(19) United States
(12) Patent Application Publication
(10) Pub. No.: US 2007/0059103 A1
(43) Pub. Date: Mar. 15, 2007

(54) Remediation Method and Apparatus

(76) Inventors: Gopal Achari, Calgary (CA); Cooper H. Langford, Calgary (CA)

Correspondence Address: THOMPSON LAMBERT LLP;c/o Berger & Altmann, 2711 JEFFERSON DAVIS HIGHWAY Suite 401A, Airport Plaza One, ARLINGTON, VA, 22202, US

(21) Appl. No.: 11/464,605

(22) Filed: Aug. 15, 2006

Related U.S. Application Data
(60) Provisional application No. 60/708,269, filed on Aug. 15, 2005.

(51) Int. Cl. A62D 3/38; B09C 1/08; A62D 3/00; B01J 19/12

(52) U.S. Cl. 405/128.5; 588/320; 422/186.3

(57) ABSTRACT

A method of degrading organic contaminants includes pre-treating the organic contaminants with an oxidizing promoter of in situ surfactant formation, extracting the organic contaminants with isopropanol (IPA) followed by treatment with UV to dechlorinate PCBs and degrade biphenyls. A photoreactor uses a plastic coil in a flow through configuration, with six UV lamps, of which five are around the coil and one at the center. The photoreaction using the photoreactor is fast and efficient.

### CROSS-REFERENCE TO RELATED APPLICATIONS

This application claims the benefit under 35 USC 119(e) of U.S. provisional application No. 60/708,269 filed Aug. 15, 2005.

### BACKGROUND

The use of ultraviolet (UV) photochemistry to degrade organics has been, and continues to be, widely researched. As well, there are quite a few large and small-scale commercial installations of UV treatment systems worldwide, mainly for disinfection. The two major issues in designing an effective photoreactor are maximizing the UV exposure to the target sample and ensuring uniformity of exposure. Due to high-energy demands these become quite important in case of recalcitrant organics and if the sample has some turbidity.

PCBs such as Arocior(tm) 1254 are recalcitrant organics that are difficult to degrade. Aroclor 1254, a commercial PCB mixture, had wide spread applications in transformer oils and capacitors, until its usage was banned. It is estimated that a third of the US production of PCBs, about 1.4×109 lbs, has made its way into the environment. PCBs, which consist of 209 different congeners are loosely classified as lower and higher chlorinated, depending on the degree of chlorination. The higher the degree of chlorination, the more recalcitrant is the PCB molecule. Arocior 1254, a highly chlorinated PCB mixture, is fairly recalcitrant and not amenable to easy degradation.

### SUMMARY

There is provided a method for the degradation of organic contaminants, particularly PCBs in soil, that comprises steps of pre-treating the organic contaminants with hydrogen peroxide without added iron, extracting the organic contaminants with an extractant followed by treatment with UV to dechlorinate PCBs and degrade biphenyls.

There is also provided a method for the degradation of organic contaminants, particularly PCBs in soil, that comprises steps of pre-treating the organic contaminants with an oxidizing promoter of in situ surfactant formation, extracting the organic contaminants with extractant followed by treatment with UV to dechlorinate PCBs and degrade biphenyls.

A photoreactor is also disclosed that is designed to ensure uniform UV exposure to the target sample and at the same time maximize the exposure period. The photoreactor is designed in one embodiment for field applications. In one embodiment, a UV photoreactor, for the degradation of organic contaminants has flexible, non-fragile UV transparent tubing forming a flow path for the organic contaminants through the active region of one or more UV lamps.

### BRIEF DESCRIPTION OF THE DRAWINGS

There will now be described embodiments of a remediation apparatus and method with reference to the drawings by way of example, in which:

FIG. 1 shows the steps of an embodiment of a remediation method;

FIG. 2 is a schematic showing an embodiment of a remediation apparatus;

FIG. 3 is a plan view of the apparatus of FIG. 2;

FIG. 4 is a graph showing degradation of a PCB by treatment with a photoreactor designed according to FIGS. 2 and 3;

FIGS. 5a-5e are concentration-time plots of different congeners in Aroclor(tm) 1254 when photodechlorinated with an apparatus designed in accordance with FIGS. 2 and 3; and

FIG. 6 is a graph showing a concentration-time plot of degradation of a solution of Aroclor(tm) 1254-IPA with water (solid line 10% water, dashed line: 30% water).

### DETAILED DESCRIPTION

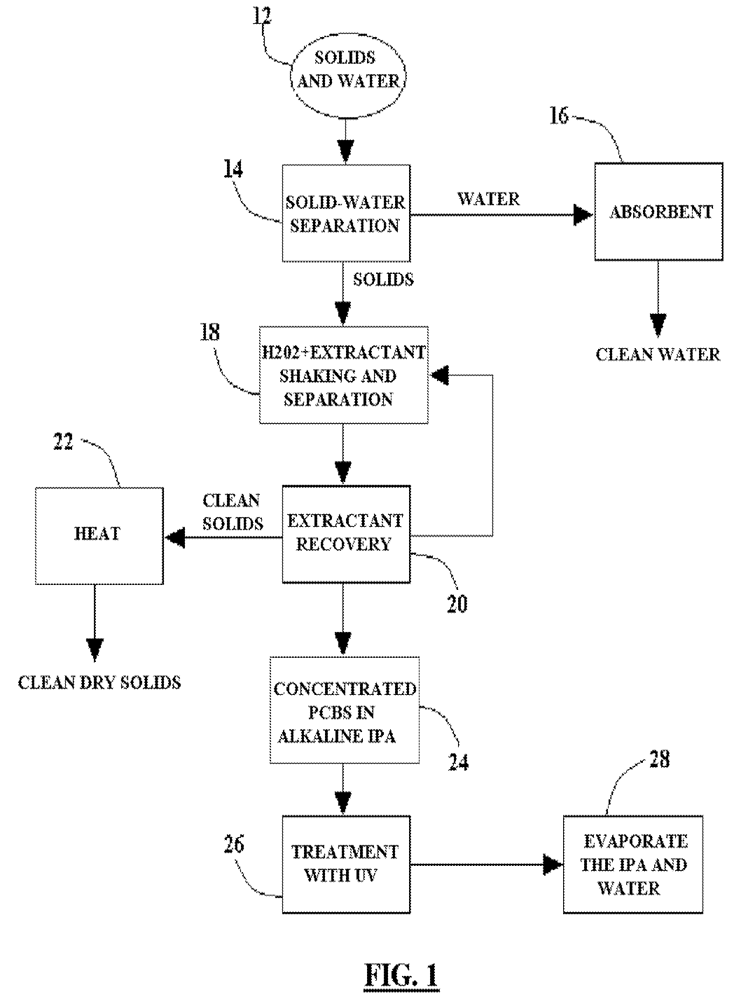

An embodiment of a technology for remediating PCB contaminated soils and sediments involves a number of steps shown in FIG. 1. Solids 12 from a contaminated site will wpically include soil or sediment, water and contaminants. Remediation typically starts with water soil separation 14, if free water is present in the soil, which is carried out according to known processes such as passing the soils and sediments through a centrifuge. Various ways may be used to separate out free water in the contaminated solids. Water separated from the soil is passed at step 16 through an absorbent bed or other water cleaning process to produce clean water. The solid fraction, after water removal, is then treated in an extraction step 18.

In the extraction step 18, the solid portion resulting from the water-solid separation, which includes some water, is then treated by contact with hydrogen peroxide before addition of extractant. As much as 0.1 L to 0.6 L of 30% hydrogen peroxide may be added for each kilogram of soil. The mixture is allowed to stand for example for about an hour. It is believed that the hydrogen peroxide pre-treatment works by promotion of oxidation of organic matter in the soil to produce carboxylate groups that are formed on the contaminants, such as transformer oil) in the soil to produce surfactants. The inventors have a reasonable basis for this understanding, but the theory cannot be guaranteed to be true. The hydrogen peroxide has the added benefit of producing radicals that degrade organic matter in the soil.

After pre-treatment with hydrogen peroxide as needed) PCBs are extracted from the pre-treated contaminated soil by contact with a non-toxic, distillable, extractant that permits safe handling, such as iso-propanol (IPA), acetone or methanol. IPA may be added to the pre-treated soil in a ratio for example from 1 L to 3 L for each Kg of soil. The extractant and soil mixture is shaken for a sufficient time for PCBs to be extracted from the soil. The extraction process may be repeated to ensure adequate removal of PCBs from the soil. The ratio of soil to extractant will be determined depending on the soil type and conditions existing in the field. Following each cycle of extraction, the extractant wll be separated from the soil and distilled to concentrate the PCBs and other organics extracted (step 20). The extractant and PCB mixture may be distilled and a large portion, for example, 95% to 99% of the extractant may be recycled for re-use in the extraction step 18.

Water extraction will not be 100% efficient. The presence of some water in the isopropanol portion has been found to have little negative impact on the resulting process. Up to about 30% water in the isopropanol portion has been found to have beneficial effects on the degradation process, but additional amounts beyond about 30% may reduce degradation.

For concentration, the extractant is drained from the soil, and the soil may be heated and disposed of by, for example, returning cleaned soil to the site from which the soil was taken (step 22).

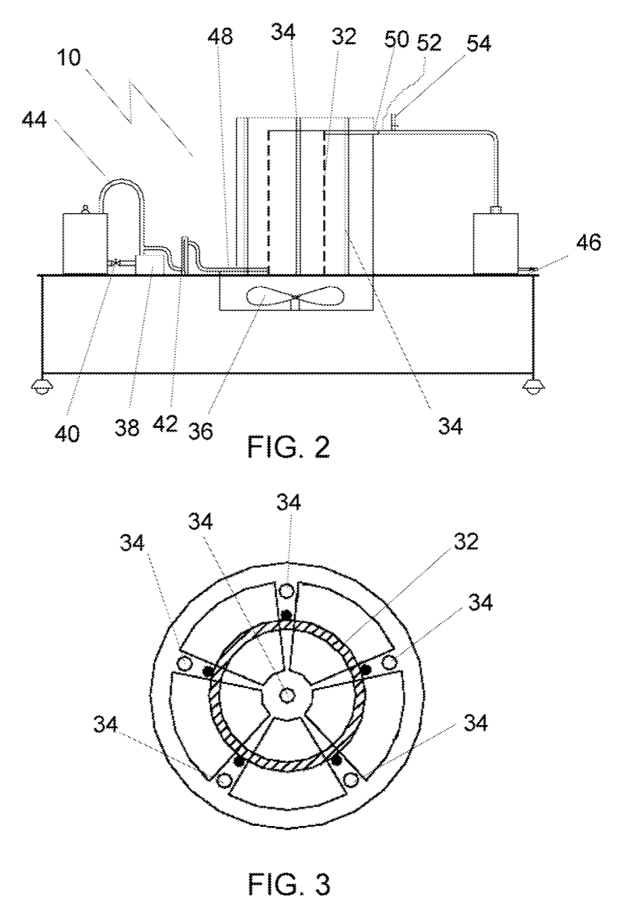

A strong base, for example, sodium hydroxide, is then added to the remaining PCB contaminated extractant to render it alkaline as for example 0.1 M (step 24). The resulting alkaline PCB contaminated extractant is then passed through a photoreactor in step 26, as for example described here in relation to FIGS. 2 and 3. Alkalinity of the extractant is believed to enhance PCB degradation through enhanced proton transfer. After treatment in the photoreactor, any remaining extractant and water may be disposed of through evaporation in step 28.

FIG. 2 presents a schematic of a flow through photoreactor 10. Referring to FIG. 2-3, the photoreactor 10 comprises in this embodiment a spiral coiled tube 32 with five UV lamps 34 on the outside of the coil and one UV lamp 34 on the inside. The UV lamps 34 each have an active region in which UV intensity is sufficient to degrade organics passing through the tube 32. The coiled tube 32 is made of a non-fragile flexible material. By non-fragile, it is meant that the tubing 32 is sufficiently resilient and flexible that it does not break during normal use. An example material is methyl vinyl ether modified tetra-fluoroethylene (MFA)® or ethylene-fluorinated ethylene propylene-copolymer (EFEP)®, available from Markel Corporation. The wall thickness, internal diameter, length, coil diameter, and coil length of the tubing 32 will depend on the intended application and volumes of fluid being treated. Other geometries of flow path may also be used to provide efficient use of the active region of the UV lamps.

The UV lamps 34 may operate at 254 nm or such other wavelength that provides effective photodegradation of the target contaminants. The coil 32 may be encased in a stainless steel jacket (not shown). Referring to FIG. 2, at the base of the photoreactor, a fan 36 may be installed to cool the coil 32. Fluid is pumped into the coil 32 from a reservoir (not shown) through a pump 38 controlled by a valve 40, and equipped with a flow meter 42. The reservoir may be connected to the photoreactor with solvent resistant plastic tubing 44. The target fluid may in one embodiment move within the photoreactor from the bottom to the top, providing better control on the flow. Use of flexible tubing 32 radically reduces the cost and risk of damage as compared with quartz tubing. The arrangement shown produces a small variation in UV intensities reaching different parts of the reaction zone, but the target sample within the closed coiled tube 32 moving upward has a uniform exposure.

Photoreactor 10 is attached directly to a work bench 46. A steel nozzle 48 is attached to the photoreactor 10, connecting plastic tubing 44 to coiled tube 32, at the point where coiled tube 32 enters photoreactor 10. Another steel nozzle 50 in turn connects coiled tube 32 at the point where coiled tube 32 leaves photoreactor 10. Steel nozzle 50 connects to a flexible pipe 52. There may be a sampling port 54 located out of flexible pipe 52, some distance downstream from steel nozzle 50. Sampling port 54 can be included for the purpose of removing small samples of solvent for quality control purposes.

In an embodiment of the method step 26, the extracted PCBs and organics that are dissolved in either alkaline isopropanol or other extractant are passed through the flow through photoreactor 10 and subjected to ultraviolet light, for example at 254 nm wavelength. The UV light should be in the absorption spectrum of the contaminant, which for PCBs will typically be in the absorption bands around 254 nm or 185 nm. The UV lamps may be any commercially available UV lamp, whether now designed or hereafter available) such as an LED lamp.

The tubing 32 may be fluorinated polypropylene (FEP) tubing, forming a flow path for the organic contaminants through the active region of one or more UV lamps. The FEP tubing is a flexible tube that is UV transparent, preferably at least 75% transparent to UV radiation in the absorption spectrum of the contaminant, and even more preferably at least 80% transparent. The FEP is a flexible material that is transparent due to the presence in the FEP of small highly electronegative atoms. In general, the FEP tubing is sufficiently transparent to the UV that, in combination with the length of the flow path, the flow rate and the UV intensity, a significant portion of the organic contaminants are degraded during passage through the flow path. The length of the flow path is maximized by a curved or folded path, for example a spiral coil wrapped around a central UV lamp with additional UV lamps spaced around the outside of the coil. Other arrangements are possible for the flow path, for example a series of loops as in a radiator with rows of UV lamps on either side of the loops. The flow path maximizes exposure to the active region of the lamps. This photoreactor is suitable for use in the field, such as at a well sites or other remote location.

The alkaline extractant/PCB liquid is passed through the reactor in step 26. IPA as the extractant provides a benefit as some of it is degraded in the photoreactor and some of its breakdown components aid degradation. IPA enhances efficiency. 1 photon of light can lead to displacement of 20 Chlorine ions. Soil can be treated on-site because of the design of the system.

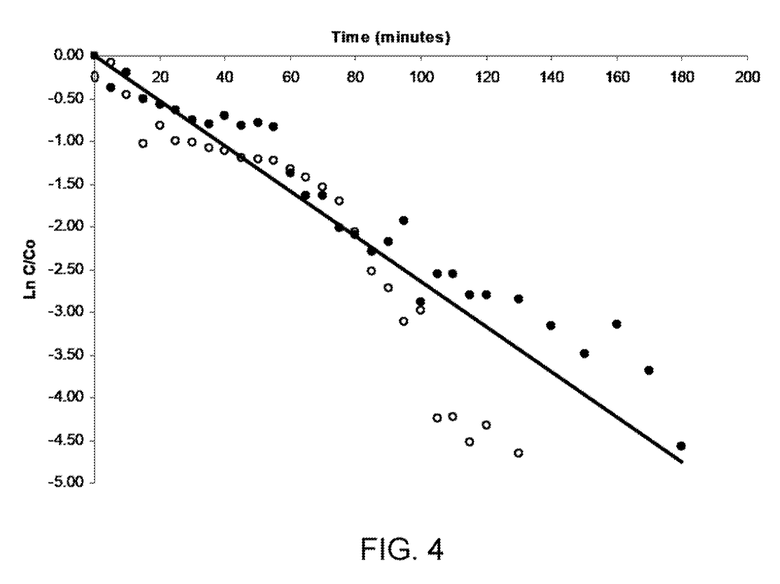

FIG. 4 shows Aroclor(tm) 1254 loss after treatment of a solution of Aroclor(tm) 1254 in IPA (the different circles show different runs) by passing the respective solutions through an exemplary photoreactor designed according to the device shown in FIGS. 2 and 3. A 4L solution of Aroclor(tm) 1254 was prepared by dissolving 1 g neat Aroclor 1254 in isopropanol. The solution was made 0.1M alkaline by adding 40 ml of 10 M NaOH. The solution was then placed on a magnetic plate and stirred for half hour to ensure homogeneity. A thin walled EFEP tube was used with a wall thickness of 0.12 mm. The coil of the photoreactor had an internal diameter of 15 cm and the length of the photoreactor was 70 cm. The internal diameter of the EFEP tube was 0.9 cm and the volume of the target fluid in the illuminated zone was about 1.5 L. The length of the coiled tube inside the photoreactor was about 2 m giving the target fluid ample travel distance. The sample flowed continuously at a flow rate of 7.8 ml/min through the coiled tube and the times recorded refer to residence time of the sample. FIG. 4 shows a significant decrease in concentration with time. The plot of FIG. 4 shows a decrease that can be fitted approximately to pseudo-first order kinetics. The approximate rate constant so obtained was 1.60 h-1 for the EFEP (thin walled) tube. The coefficient of regression (r2) for the plot was 0.84. These values imply 99% reduction in Aroclor(tm) 1254 within 2.87 h when the EFEP (thin walled) tube is used. A 90% reduction in Aroclor(tm) 1254 concentration would occur within half this time for the EFEP tube.

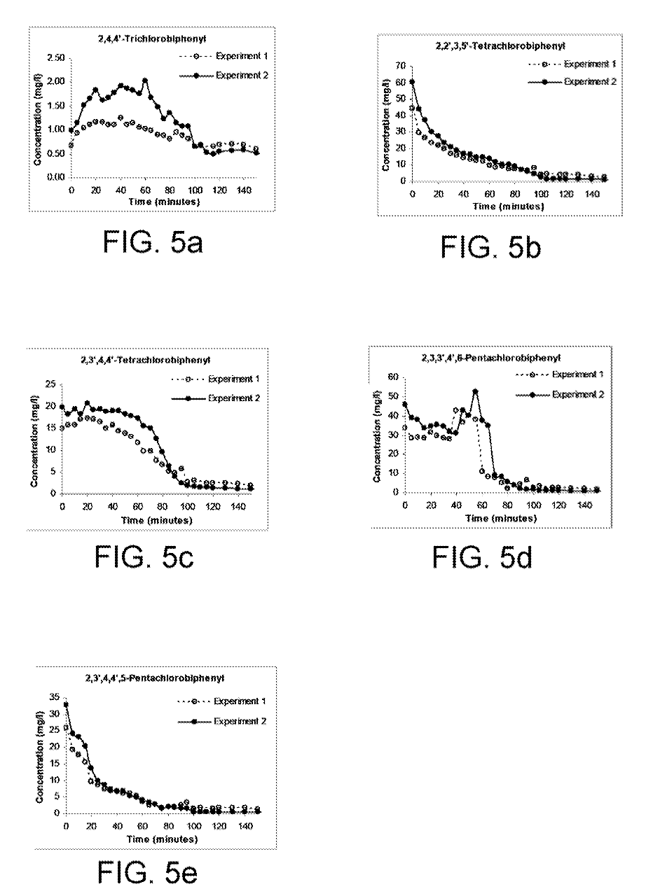

FIGS. 5a-5e presents graphs showing variation of concentration with time of different congeners of Aroclor(tm) 1254 when treated with a photoreactor designed in accordance with the apparatus of FIGS. 2 and 3 using a thin walled EFEP tube. The concentrations of the different congeners were determined by a comparison of the area under specific peaks with that of Aroclor 1254, hence do not represent actual values. In this investigation, it has been used for relative comparison to investigate the loss or production during photodegradation. Open circles and filled in circles indicate different runs. The two pentachlorobiphenyls have different loss trends. The 2,3,3′,4′,6 pentachlorobiphenyl shows little loss during the initial periods. In contrast the loss of 2,3′,4,4′,5 pentachlorobiphenyl starts almost immediately. Similar results are obtained when the loss of 2,2′,3,5′ tetrachlorobiphenyl is compared with that of 2,3′,4,4′ tetrachlorobiphenyl. Measurement protocols, additional results for a thicker walled EFEP tube and an MFA tube, and a discussion of the effect of different congeners on photodechlorination of Aroclor(tm) 1254 are to be found in the provisional application from which priority is claimed, the content of which is incorporated by reference herein.

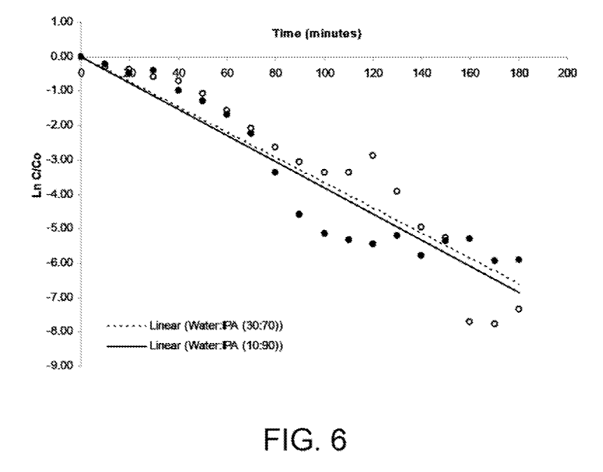

The effect of water on photodegradation of a PCB in IPA is shown in FIG. 6. Aroclor(tm) 1254 was dissolved in IPA, which was then made alkaline with sodium hydroxide. Water was added to the IPA and the mixture of IPA-water was then homogenized by using a rotary mixer for 2 hours. If the reaction kinetics is modeled as pseudo-first order then the rate constants are: 2.2 h-1 and 2.3 h-1 when 30% and 10% water were used respectively. The coefficients of regression for both the plots are 0.89 and 0.09 respectively. Again, the use of first order kinetics for mixtures seems a practical tool as it can provide an estimate of the percent dechlorination within a reasonable error. The reaction rate constants are somewhat higher than the ones obtained when water was not used, indicating that the presence of moisture helps in the photodechlorination of Aroclor(tm) 1254. This is believed to be due to water being a more favorable solvent system for proton transfer than IPA. Data with water for the five different congener variations with time are provided in the provisional application from which priority is claimed. The trends of the congener dechlorination with time are similar. Here again, the 2,3,3′,4′,6 pentachlorobiphenyl shows a slower dechlorination initially compared to 2,3′,4,4′,5 pentachlorobiphenyl, which is lost faster. Similarly, the 2,3′,4,4′ tetrachlorobiphenyl has an initial loss rate which is much lower than at a later time. This suggests that both 2,3′,4,4′ tetrachlorobiphenyl and 2,3,3′,4′,6 11 pentachlorobiphenyl are being formed, as a product of dechlorination of higher congener PCBs, as they are dechlorinated.

Isopropanol, acetone and methanol were tested for their extraction efficiencies using three cycles and a soil-solvent ratio of 1:3 (g of wet soil:ml of solvent) on two different soils. The soils had a dark brown color with appreciable amounts of water and visible organic matter. They had a sweet aromatic odor and evident oil sheen. The clay content in these soils was also high giving them a sticky texture. These samples had PCB concentrations of about 475 mgkg⁻¹ and 1350 mgkg⁻¹ respectively. The PCB contamination in the soils was primarily by Aroclor(tm) 1254. One of the soils was a clayey soil with 35.2% moisture and 13.5% organic matter and an Aroclor(tm) 1254 concentration of 475 mgkg⁻¹. The other was a clayey soil with 48.9% moisture and 14.4% organic matter and an Aroclor(tm) 1254 concentration of 1350 mgkg⁻¹.

For each soil, a sample of about 200 g of PCB contaminated soil was manually homogenized. All solvent extraction experiments were conducted with 50 g subsamples from the homogenized soil and pretreated with 10 ml of 30% H₂O₂. The extracting solvent was then added to the soil samples in ratios of 1:3 (g of wet soil:ml of solvent) or 1:1. Multicycle shake extraction was conducted using three different solvents (acetone, methanol and IPA). In each cycles the extractant-soil mixture was shaken vigorously in a wrist action shaker for 45 minutes. Prior experiments had indicated that a shake period of 45 minutes was appropriate. Following the shaking, the samples were centrifuged for 15 minutes at about 1800 rpm. The supernatant was separated and analyzed for PCBs after passing it through sodium sulphate cartridge for dewatering and silica gel cartridge to remove any polar compounds. The supernatant (extractant), containing the extracted PCBs, was concentrated by distillation. The solvent recovered was reused for the next cycle. Three to five successive extraction cycles were conducted to extract the PCBs from the soil. Small aliquots were collected both before and after distillation of the extracting solvent and analyzed for PCBs. Finally, in order to estimate total solvent extractable PCBs in the samples, about 15 g of the soil from each sample was subjected to Soxhlet extraction following USEPA 3540C using a hexane/acetone mixture in a ratio of 1:1 (v/v) to determine the PCBs remaining in the soil. The extractant collected after 24 hours was evaporated to dryness and hexane was added as the transfer solvent. The hexane-PCB mixture was then sonicated for half an hour and analyzed for PCBs.

The results indicate that the extraction efficiency was the highest for acetone followed by IPA and methanol, for both soils tested. Acetone extracted 90% or more Aroclor 1254 in three cycles. The average extraction recoveries achieved after 3 cycles using IPA and methanol were 82% and 76% respectively. Since both soils had high clay content, organic matter as well as moisture in the soil, these factors contributed to the extraction efficiency. The average extraction efficiency for methanol was lower than both acetone and IPA.

A consideration of the different PCBs fractions extracted by acetone, IPA and methanol shows that the lower chlorinated fractions eluting at early retention times are less extracted by the different solvents compared to middle and higher chlorinated congeners eluting at higher retention times. All three solvents showed the same trend. The extraction recoveries obtained for Aroclor(tm) 1254 were observed to be higher than total PCBs since most of the Aroclor(tm) 1254 peaks lie within the retention time window of 26-36 min which showed efficient recoveries.

Extraction of PCBs with acetone and IPA was analyzed with the extraction extended to 5 extractant cycles and the soil-solvent ratio was 1:1 (g of wet soil:ml of solvent). When comparing the extraction efficiency for the same solvents on the same soils 1 and 2, the Aroclor(tm) 1254 extracted from a first sample using 1:1 soil-IPA ratio after five cycles was 89-91% whereas similar experiment on the same soil yielded 81% Aroclor 1254 after 3 cycles when the soil solvent ratio was 1:3. The extraction of Aroclor 1254 from soil 2 sample using acetone was 78-84% when the soil solvent ratio was 1:1. In an equivalent experiment using 1:3 soil solvent ratio the extraction efficiency after 3 cycles of extraction was 95%. Studies of the extraction of different PCBs fractions based on retention time windows by acetone and IPA show that acetone extracts all the congeners almost uniformly during all the extraction cycles when 1:1 soil solvent ratio was used. IPA, on the other hand, preferentially extracts the higher chlorinated fractions eluting at higher retention times during the first three cycles and in the subsequent cycles the lower chlorinated congeners are extracted more.

When PCB contaminated weathered soil is pretreated with H₂O₂ and then extracted with IPA, the efficiency of PCB extraction increased. In an example using a separate air dried, grounded and sieved soil with 2.1% moisture and 12.2% organic matter and an Aroclor(tm) 1254 concentration of about 740 mgkg⁻¹, about 66% of PCBs were extracted using IPA alone (1:3 soil to solvent ratio). When 0.5 ml (H₂O₂:soil=0.05 ml:1 g) of 30% H₂O₂ was used, the extraction efficiency increased to 73%. It increased further to 75% with the addition of 1 mL of 30% H₂O₂.

In an example using the clayey soil 2 with 48.9% moisture and 14.4% organic matter and an Aroclor(tm) 1254 concentration of about 1350 mgkg⁻¹, and IPA was used in 1:3 soil to solvent ratio, 51% Aroclor 1254 is extracted by IPA when the soil is not pretreated with H₂O₂. When 30% H₂O₂ is added in a ratio of 0.1:1 (ml of H₂O₂/g of soil) the extraction efficiency increased to about 54%. 55% extraction was measured with the addition of 0.6:1 ratio of 30% H₂O₂.

Immaterial modifications may be made to the remediation process and apparatus described here without departing from what is claimed. Use of the indefinite article before an element in the claims does not exclude more than one of the element being present. The word comprising does not exclude other elements or steps being present.

What is claimed is:

1. A method for the degradation of organic contaminants in soil, the method comprising steps of:
contacting the organic contaminants with hydrogen peroxide without added iron to produce pre-treated organic contaminants;
extracting the pre-treated organic contaminants from the soil with an extractant; and
exposing the extracted organic contaminants to ultraviolet light.

2. The method of claim 1 in which the soil contains water, and the method further comprising the step of separating water from the soil prior to contacting the organic contaminants with hydrogen peroxide.

3. The method of claim 2 in which the extractant is isopropanol.

4. The method of claim 3 in which the organic contaminants comprise PCBs.

5. The method of claim 4 carried out at a field facility.

6. A photoreactor, comprising:
one or more UV lamps, each UV lamp having an active region;
tubing made of a flexible, non-fragile UV transparent material; and
the tubing forming a flow path for organic contaminants through the active regions of the one or more UV lamps.

7. The photoreactor of claim 6 in which the tubing is made at least partially of fluorinated polyethylene tubing.

8. The photoreactor of claim 6 in which the tubing forms a spiral flow path.

9. The photoreactor of claim 8 in which:
the one or more UV lamps include at least a central UV lamp; and
the spiral flow path is formed around the central UV lamp.

10. The photoreactor of claim 9 in which the one or more UV lamps include plural UV lamps distributed around the spiral flow path formed by the tubing.

11. A method for the degradation of organic contaminants in soil, the method comprising the steps of:
contacting the organic contaminants with an oxidizing promoter of in situ surfactant formation to produce pre-treated organic contaminants;
extracting the pre-treated organic contaminants from the soil with an extractant; and
exposing the extracted organic contaminants to ultraviolet light.

12. The method of claim 11 in which the soil contains water, and the method further comprising the step of separating water from the soil prior to contacting the organic contaminants with hydrogen peroxide.

13. The method of claim 12 in which the extractant is isopropanol.

14. The method of claim 13 in which the organic contaminants comprise PCBs.

15. The method of claim 14 carried out at a field facility.
